(19) United States
(12) Patent Application Publication
(10) Pub. No.: US 2014/0068026 A1
(43) Pub. Date: Mar. 6, 2014

(54) SYSTEM FOR AUTOMATICALLY CONFIGURING SERVER USING PRE-RECORDED CONFIGURATION SCRIPT AND METHOD THEREOF

(71) Applicants: INVENTEC (PUDONG) TECHNOLOGY CORPORATION, (US); INVENTEC CORPORATION, Taipei (TW)

(72) Inventor: Meng SUN, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/795,231

(22) Filed: Mar. 12, 2013

(30) Foreign Application Priority Data
Aug. 31, 2012 (CN) 201210319854.7

(51) Int. Cl. H04L 12/24

(52) U.S. Cl. CPC H04L 41/08
USPC 709/220

(57) ABSTRACT

A system for automatically configuring a server using a pre-recorded configuration script and a method thereof are provided. After transmitting an installation configuration frame displayed by a server from a controller to an operating device when the server configures a target program, the operating device sends interaction data corresponding to a graphic feature prerecorded in a configuration script from the operating device to the controller when the installation configuration frame matches to the graphic feature. The controller provides the interaction data to the target program being configured so that the configuration of the target program automatically enters the next stage. The system and the method can finish configuring a server automatically, and can achieve the effect of quickly configuring a lot of servers of the same type.

### BACKGROUND OF THE INVENTION

1. Field of Invention

The invention relates to a system of configuring a server and the method thereof. In particular, the invention relates to a system that automatically configures a server using a pre-recorded configuration script and the method thereof.

2. Related Art

With the popularity of the Internet, more and more services are provided by servers connected to the network. The service servers are installed with operating systems. The operating systems installed on the servers run applications corresponding to the services provided by the servers.

In fact, to configure a server that provides services on the network, one usually needs to prepare various files of the operating system on the server and the service applications. One also needs to understand the processes of installation and configuration. When configuring the server, the administrator first installs and sets up an operating system on the server. After the completion of the installation and configuration of the operating system, the administrator continues to install and configure applications for the services. The configuration of the server is finished after the completion of the installation and configuration of the applications.

Configuration of the operating system and applications often requires the administrator to key in characters or click and cannot be done automatically. If the administrator does not provide inputs, the operating system and applications configuration procedures will remain at the same stage. Therefore, the administrator usually does not leave the server during the process of configuration. In other words, the administrator has to stay next to the server for some time during the configuration until the server configuration is done. As a result, the administrator needs to spend a lot of time when configuring a large number of servers.

In summary, the prior art always has the problem that server configuration cannot be done automatically. It is imperative to provide an improved means to solve this problem.

### SUMMARY OF THE INVENTION

In view of the foregoing, the invention discloses a system that automatically configures a server using a pre-recorded configuration script and the method thereof.

The disclosed system includes: a transmission module for connecting with a controller; a script loading module for loading a pre-established configuration script that contains interactive graphic features for interactive operations for configuring the corresponding target program and the interactive data for the inputs of interactive operations, with the graphic features corresponding to the interactive data; a configuration notification module for notifying the controller to configure the target program in the server; a configuration processing module for receiving an installation configuration frame displayed by the server while configuring the target program from the controller and for determining whether the installation configuration frame matches to the graphic feature. When the installation configuration frame matches to the graphic feature, the configuration processing module transmits interactive data corresponding to the graphic feature in agreement with the installation configuration frame to the controller. The controller provides the interactive data to the target program, in order for the configuration process of the target program to enter the next stage.

The disclosed method of automatically configuring a server using a pre-recorded configuration script includes the steps of: connecting an operating device to a controller in a server; using the operating device to notify the controller to configure a target program in the server; using the controller to transmit an installation configuration frame displayed by the server when configuring the target program to the operating device; using the operating device to determine whether the installation configuration frame matches to the graphic feature in the configuration script and, if so, to transmit interactive data corresponding to the graphic feature to the controller; and using the controller to provide the interactive data to the target program so that the configuring process of the target program enters the next stage.

The disclosed system and method differ from the prior art in that after transmitting an installation configuration frame displayed by a server from a controller to an operating device when the server configures a target program, the operating device sends interaction data corresponding to a graphic feature prerecorded in a configuration script from the operating device to the controller when the frame matches to the graphic feature. The controller provides the interaction data to the target program being configured so that the configuration of the target program automatically enters the next stage. The system and the method can finish configuring a server automatically, and can achieve the effect of quickly configuring a lot of servers of the same type.

### BRIEF DESCRIPTION OF THE DRAWINGS

The invention will become more fully understood from the detailed description given herein below illustration only, and thus is not limitative of the present invention, and wherein:

FIG. 1 shows the disclosed system of automatically configuring a server using a pre-recorded configuration script.

FIG. 2A shows the disclosed method of automatically configuring a server using a pre-recorded configuration script.

FIG. 2B is a flowchart of the appended method of selecting controller according to the invention.

FIG. 3 is a flowchart of the appended method of recording configuration script according to the invention.

### DETAILED DESCRIPTION OF THE INVENTION

The present invention will be apparent from the following detailed description, which proceeds with reference to the accompanying drawings, wherein the same references relate to the same elements.

During the configuration of a target program in a server, the invention can record the graphic features of the interactive frame for interactive operations in the configuring process and the interactive data inputted during the interactive operations for the graphic features in the interactive frame. The recorded graphic features and the corresponding interactive data are added to the configuration script of the corresponding target program. When other servers are required to configure the same target program later on, the corresponding configuration script is used to control the server for automatic target program configuration, without any manual operations. The server for recording the graphic features in the configuring process and the corresponding interactive data is referred herein as the ‘recording device’. In addition to a device that provides specific services on the Internet, the server configured with the target program can be a desktop computer or a laptop computer according to the invention.

The configuration of the target program refers to the process required to make the target program normally operate on the server, including the installation or setting of the target program on the server. The target program can be any system, software or program that is installed on the server to provide services. For example, it can be the server's operating system (OS), web page server software, database management system, file server software, or lightweight directory access protocol (LDAP). However, the target program is not limited to the above-mentioned examples.

The interactive operations referred herein include, but are not limited to, character inputs and cursor clicks that require the user of input devices such as keyboard and mouse for interactive data inputs. The interactive data referred herein are data inputted for interactive operations. They differ with different input operations. For example, if an interactive operation is character input, then the interactive data are one or multiple characters inputted via a keyboard. If an interactive operation is cursor click, then the interactive data include mouse single click, double clicks, or long click along with the clicked coordinates. They may also simulate characters input via a keyboard. The interactive data referred herein are not limited to such possibilities.

The interactive frame referred herein is a frame displayed by the server for the input of the interactive data for the interactive operations when the server configures a target program. The graphic features referred herein are data of specific interactive frames extracted from multiple interactive frames. They can be part of the interactive frame or data generated after specific operations on the interactive frames. The invention does not have any specific limits on them.

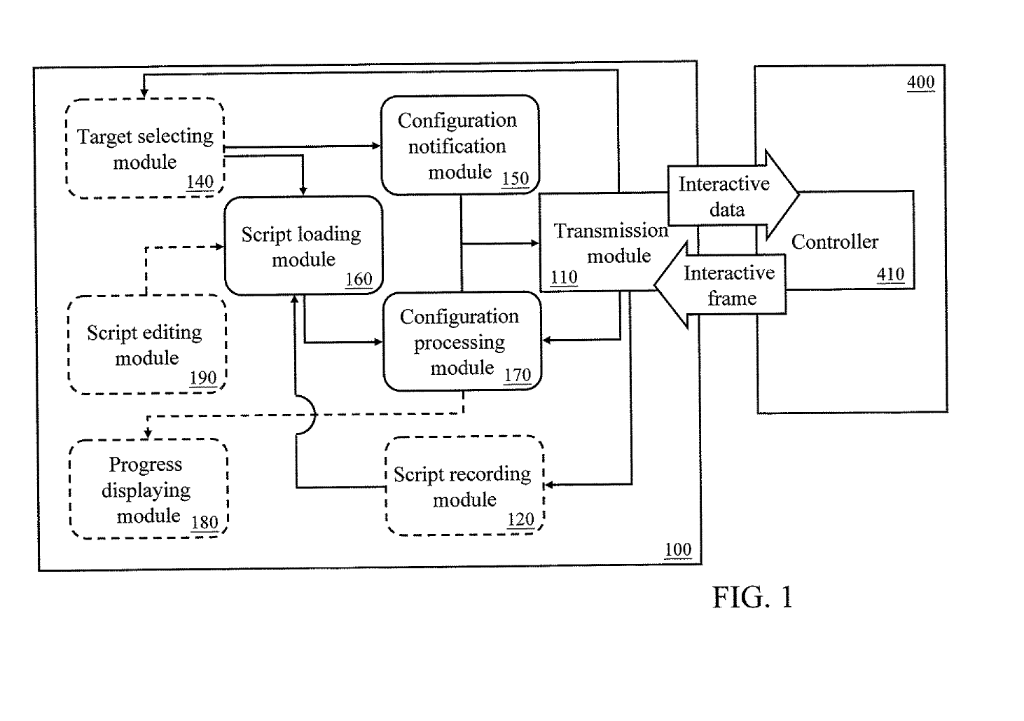

FIG. 1 shows the disclosed system of automatically configuring a server using a pre-recorded configuration script. As shown in the drawing, the disclosed system is used in an operating device 100 and includes a transmission module 110, a configuration notification module 150, a script loading module 160, and a configuration processing module 170.

The operating device 100 is a device that provides interactive operations and exchange data with the server 400, including but not limited to mobile phone, personal digital assistants (PDA), tablet computer, laptop computer, and desktop computer.

The transmission module 110 connects to a controller 410 of the server 400. In general, the transmission module 110 connects to the controller 410 via the transmission interface (not shown) of the operating device 100. The controller 410 can be, but not limited to, the remote control card, such as integrated lights-out (iLO) or base management controller (BMC), that can obtain operation information of the server and control the operation elements thereof. The operation information obtained by the controller 410 includes the data or signals output by the server, such as the hardware status, control signal, or displayed images. The invention is not limited to these possibilities.

In some embodiments, the transmission module 110 can use the transmission interface of the operating device 100 to search various controllers that can normally operate in different servers through the Internet. However, the transmission module 110 is not limited to this ease.

The configuration notification module 150 notifies the controller 410 so that the controller 410 follows the notification to control the server 400 to configure the target program. Generally speaking, the configuration notification module 150 can transmit the notification signal to the controller 410 through the transmission module 110. However, the method for the configuration notification module to notify the controller 410 is not limited to this one.

When the process for the server to configure the target program is to install the target program, the target program may not be stored in the server 400. In this case, the controller 410 needs to control the server 400 to load the target program from the storage media in the server 400, to download the target program from the Internet, or to control the server 400 to mount a virtual hard disk (VHD) storing the target program. Moreover, the controller 410 can control the server 400 to receive the target program transmitted by the operating device 100, thereby installing the target program. The invention does not restrict the storage location of the target program.

When the process for the server to configure the target program is to set the target program, the controller 410 can open the setting interface of the target program. When the setting interface can be opened only when the target program is running, the controller 410 can further control the server 400 to run the target program for the setting task.

The script loading module 160 loads the configuration script corresponding to the target program installed on the server 400. The configuration script loaded by the script loading module 160 is pre-established. The script loading module 160 can load the configuration script from the storage media (not shown) of the operating device 100 or download the configuration script from an external server through the Internet via the transmission interface of the operating device 100. The invention does not have any particular restriction on this.

The configuration processing module 170 receives the installation configuration frames extracted when the controller 410 configures the target program on the server 400. The installation configuration frames referred herein include interactive frames and display frames. The display frame is the frame that does not require interactive operations while the server 400 configures the target program. For example, it can display the installation progress or the functions of the target program. However, the display frame of the invention is not limited to such possibilities.

The controller 410 can extract the video stream output by the display card (not shown) of the server 400 when the server 400 configures the target program, and sends the extracted video stream to the operating device 100 so that the configuration processing module 170 receives the video stream containing the installation configuration frame sent from the controller 410 via the transmission module 110. The video stream extracted by the controller 410 includes various installation configuration frames generated during the configuration of the target program. The installation configuration frames contained in the video stream include the display frames that provide specific information to the user and the interactive frames required for interactive operations.

When the server 400 configures the target program, the controller 410 can also detect the video stream output by the display card of the server 400. When the number of consecutively same installation configuration frames in the video stream reaches a predetermined quantity or the same installation configuration frame persists within a predetermined time, the controller 410 determines that the installation configuration frame is not a display frame but an interactive frame. Therefore, the controller 410 can extract the consecutively same installation configuration frame from the video stream, and sends the extracted installation configuration frame to the operating device 100. The operating device 170 receives the installation configuration frame sent from the controller 410 via the transmission module 110.

The configuration processing module 170 also determines whether the installation configuration frame received from the controller 410 matches the graphic features in the configuration script. The graphic features referred herein can be a complete interactive frame, some parts thereof, or data obtained from specific operations on the interactive frame. The invention does not have any particular restriction on this, as long as different interactive frames can be effectively distinguished.

When the graphic features are the complete interactive frame or some parts thereof, the configuration processing module 170 utilizes graphics recognition techniques to determine whether the received installation configuration frame contains the graphic features. If so, it means that the received installation configuration frame matches the graphic features of the configuration script. If not, then the received installation configuration frame does not match the graphic features of the configuration script. When the graphic features are data obtained after specific operations on the interactive frame, the configuration processing module 170 performs the same operation on the received installation configuration frame and compares the result with the graphic features in the configuration script. If they match, then the received installation configuration frame matches the graphic features in the configuration script. If not, then the received installation configuration frame does not match the graphic features in the configuration script.

The controller 410 not only transmits the installation configuration frames, but the video stream containing the installation configuration frames. Therefore, when the configuration processing module 170 receives the video stream sent from the controller 410, it performs the above-mentioned comparisons for each of the installation configuration frames in the video stream, thereby determining whether each of the installation configuration frames matches the graphic features. The configuration processing module 170 can first determine whether the video stream has consecutively same installation configuration frames. If so, the configuration processing module 170 makes the above-mentioned comparison, thereby determining whether the consecutively same installation configuration frames match the graphic features.

When the configuration processing module 170 determines whether the received installation configuration frames match the graphic features in the configuration script, it transmit the interactive data corresponding to the graphic features of the matched installation configuration frame in the configuration script to the controller 410 via the transmission module 110. After the controller 410 receives the interactive data from the operating device 100, it directly takes the interactive data as the input of the server 400 and provides the interactive data to the configured target program so that the configuration procedure can continue on to the next stage.

Besides, the invention can further include an appendable script recording module 120, a target selecting module 140, a progress displaying module 180, and a script editing module 190.

After the transmission module 110 connects to the controller 410 of the recording device, the script recording module 120 receives installation configuration frames and interactive data extracted by the controller 410 of the recording device via the transmission module 110 while the recording device configures the target program.

When the controller 410 of the recording device extracts the interactive data input by the input device of the recording device, it transmits both the installation configuration frames extracted from the video stream output by the display card of the recording device and the extracted interactive data to the operating device 100. In this case, the installation configuration frames extracted by the controller 410 are also the interactive frames for the interactive data to be inputted.

The script recording module 120 can also generate graphic features according to the interactive frames, and add the generated graphic features and the interactive data inputted into the interactive frames into the configuration script corresponding to the configured target program. The script recording module 120 can use the complete interactive frame or extract some parts thereof as the graphic features. Alternatively, it can perform specific calculations on the interactive frame to generate data as the graphic features. The invention does not have any particular restriction on this.

When the transmission module 110 finds multiple controllers on the Internet, the target selecting module 140 selects one controller from them for the configuration notification module 150 to notify the selected controller.

The progress displaying module 180 shows the progress done by the server 400 on the target program. The progress displaying module 180 can use bars, values, or percentages to show the progress of the configuration done by the server 400 on the target program. There is no particular restriction by the invention.

The progress displaying module 180 can use the amount of installation configuration frames that match graphic features to show the progress of the configuration done by the server 400 on the target program. The progress displaying module 180 can also use the amount of installation configuration frames that match graphic features and the number of all graphic features in the configuration script to show the progress of the configuration done by the server 400 on the target program.

For example, ‘2/8’ means that there are eight graphic features in the configuration script, and the configuration processing module 170 has processed two of them. Moreover, the progress displaying module 180 can use the amount of installation configuration frames that match graphic features and the corresponding times of the graphic features in the configuration script to show the progress of the configuration done by the server 400 on the target program. For example, suppose that the configuration processing module 170 already processes two graphic features and the corresponding times in the configuration script are respectively 2 minutes and 8 minutes, while the total time for all the graphic features in the configuration script is 20 minutes. Then the progress displaying module 180 can show the progress as 50%. However, the method of showing the configuration progress used by the progress displaying module 180 is not restricted to those examples mentioned above.

The script editing module 190 can edit the configuration script loaded by the script loading module 160, so that the edited configuration script is more suitable for the server to configure the target program. For example, the script editing module 190 can modify the computer name in the configuration script as the server name, or change the predetermined parameters (e.g., RAID type, disk partition sizes, etc.) therein.

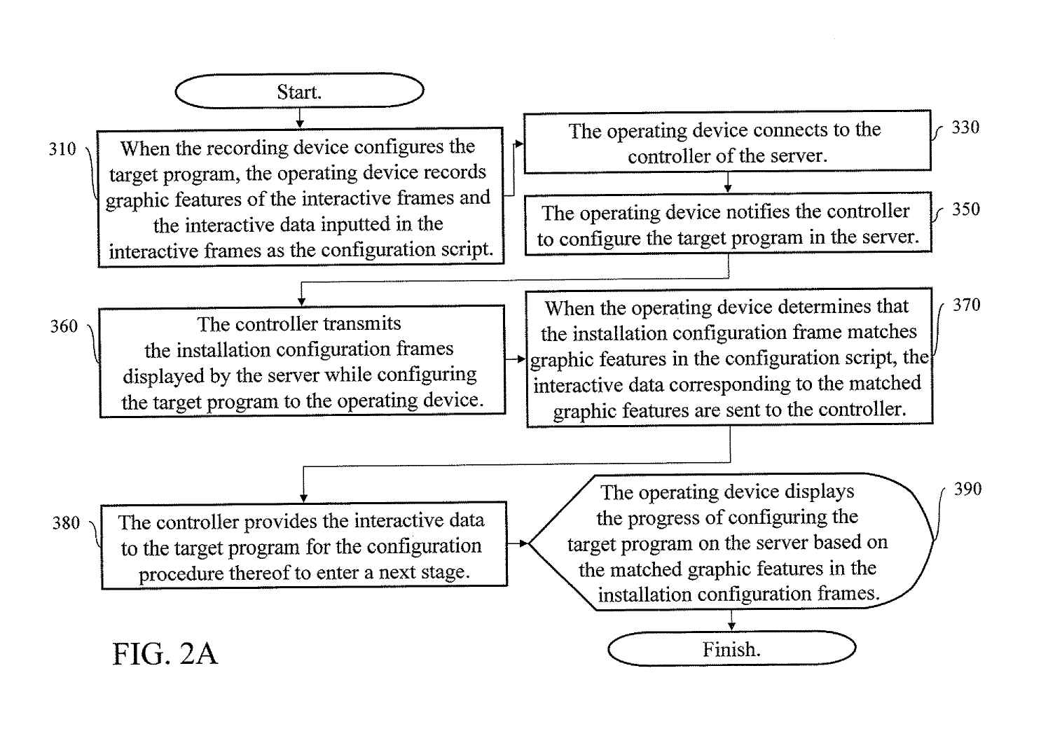

In the following, a first embodiment is used to explain the operations of the disclosed system and method. Please refer to FIG. 2A for a flowchart of the disclosed method for automatically configuring a server using a pre-recorded configuration script. In this embodiment, the target program is assumed to be an operating system (OS). However, the invention is not limited to this example. For example, the target program can also be web page server software or database management systems.

Before the user uses the operating device to control the server to automatically configure the target program, if there is no corresponding configuration script for the target program on the server, the user has to establish one such configuration script for the target program. In this embodiment, suppose the user can connect to the transmission module 110 of the operating device 100 and the controller on the recording device through the Internet, and start the script recording module 120 of the operating device 100. When the user operates the recording device to configure the target program, the controller thereof can transmit the interactive frames output while configuring the target program and the interactive data inputted by the user to the operating device 100. The script recording module 120 of the operating device 100 records the generated graphic features and the received interactive data into the configuration script accordingly (step 310).

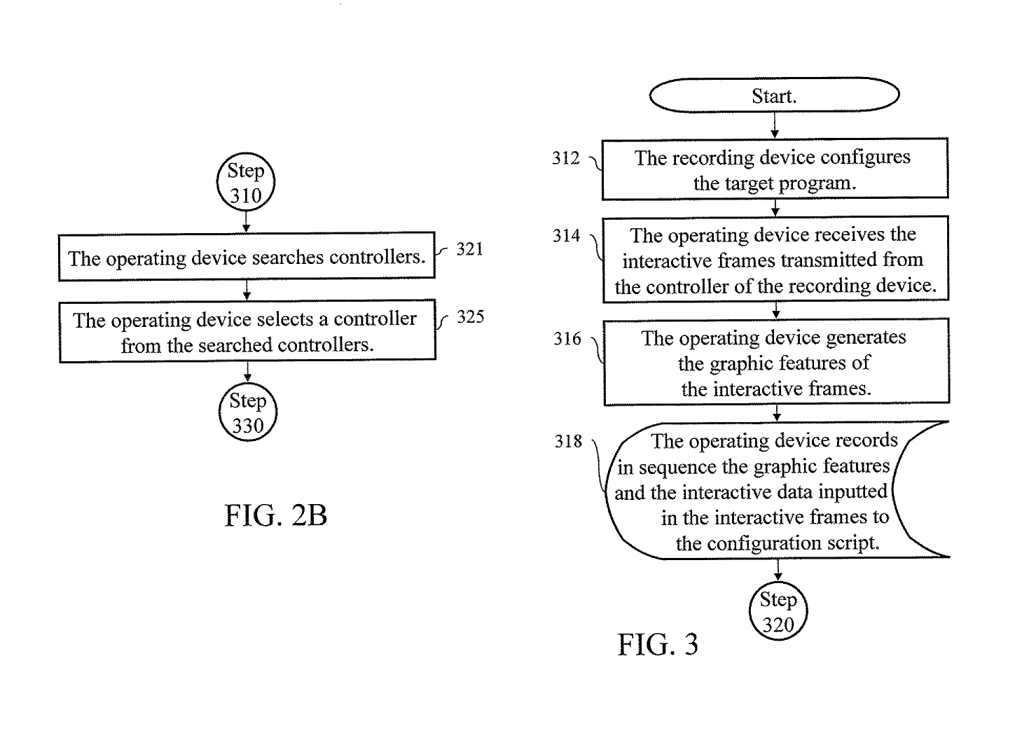

If, as shown in FIG. 3, the controller on the recording device allows the user to operate the recording device to configure the target program (step 312), the video stream output by the display card of the recording device is extracted and sent to the operating device 100. The script recording module 120 of the operating device 100 receives the video stream of all installation configuration frames as the user operates the recording device to configure the target program. When the interactive data transmitted by the controller are received, the interactive frames are extracted from the received video stream (step 314). For example, such interactive frames include the frame of the disk for OS installation, the frame of inputting system administrator account name and password, the frame of selecting OS or web server software installation, and the frame of clicking ‘Next’ or ‘Finish’.

After extracting the interactive frames, the script recording module 120 of the operating device 100 generate the graphic features of all of the interactive frames (step 316). According to the order of the extracted interactive frames, the graphic features and the interactive data inputted in the extracted interactive frames are recorded into the configuration script corresponding to the target program that the recording device is configuring (step 318). One or more users can repeat the above procedure to establish different configuration scripts in their respective recording devices.

Please refer to FIG. 2A again. After the configuration script of the target program is established, the user can use the operating device 100 to control the server 400 to automatically configure the target program. First, the transmission module 110 of the operating device 100 connects to the controller 410 of the server 400 that is about to configure a target program (step 330). In this embodiment, as shown in FIG. 2B, the transmission module 110 first searches in the Internet a controller running normally on the server (step 321). The display frame of the operating device 100 shows such identification data as the computer name and/or network address of the controller thus found, thereby allowing the user to select the server to be configured with the target program.

After the user selects the identification data of the server to be configured with the target program on the operating device 100, if the operating device 100 still contains the target selecting module 140 then the target selecting module 140 can select the controller on the server selected by the user (step 325). The transmission module 110 then connects to the controller 410 of the server 400 to be configured with the target program (step 330).

In some embodiments, the user can directly input the identification data of the server to be configured with the target program via the operating device 100. The transmission module 110 of the operating device 100 can use the inputted identification data to directly connect to the controller 410 of the server 400 to be configured with the target program (step 330). The invention does not impose any particular constraint on this.

After the transmission module of the operating device 100 connects to the controller 410 of the server 400 (step 330), the script loading module 160 of the operating device 100 searches the configuration scripts stored in the storage media of the operating device 100 and searches those stored on external devices on the Internet via the transmission module 110 of the operating device. After the searches are complete, the display frame of the operating device 100 shows the configuration scripts thus found for the user to select the one corresponding to the target program to be configured.

After the user selects a configuration script, the script loading module 160 of the operating device 100 loads the configuration script selected by the user. If the configuration script selected by the user is stored in the storage media of the operating device 100, the script loading module 160 downloads the configuration script from the storage media of the operating device 100. If the configuration script selected by the user is stored on an external device, the script loading module 160 connects to the external device on the Internet to download the configuration script via the transmission module 110 of the operating device 100. In practice, if the script loading module 160 only finds one configuration script corresponding to the target program, the script loading module 160 does not need to display it but directly loads it.

If the operating device 100 further includes a script editing module 190 in this embodiment, the user can modify the contents of the configuration script after it is loaded by the script loading module 160 of the operating device 100, e.g., modifying the disk partition size, installation directory of the target program, etc. The script editing module 190 can edit the configuration script according to the modified contents of the user so that the edited configuration script is more suitable for the server 400.

After the script loading module 160 of the operating device 100 loads the configuration script, the configuration notification module 150 of the operating device 100 notifies the controller 410 to configure the target program on the server 400 (step 350).

After the controller 410 receives the notification from the configuration notification module 150 of the operating device 100, it controls the server 400 to start configuring the target program accordingly. Suppose in this embodiment the controller 410 controls the server 400 to install the target program according to the notification, then the controller 410 can control the server 400 to read the target program from the storage media of the server 400 or to load the target program from the Internet so that the server 400 can install the target program. If in this embodiment the controller 410 controls the server to configure the target program according to the notification, the controller 410 controls the server 400 to run the target program and to open a configuration interface so that the server 400 can configure the target program.

When the server 400 configures the target program, the controller 410 sends the installation configuration frames displayed by the server 400 to the operating device 100 (step 360). In this embodiment, suppose the controller 410 extracts the video stream output by the server 400 while configuring the target program. The video stream is then sent to the operating device 100. Thus, the configuration processing module 170 of the operating device 100 receives the video stream containing the installation configuration frames sent by the controller 410 via the transmission module 110 of the operating device 100.

Besides, in some embodiments, the controller 410 extracts continuously same installation configuration frames from the video stream when it determines that the video stream has continuously several same installation configuration frames. The extracted installation configuration frames are sent to the operating device 100. Therefore, the configuration processing module 170 of the operating device 100 can use the transmission module 110 of the operating device 100 to receive the installation configuration frames sent from the controller 410.

After the configuration processing module 170 of the operating device 100 receives the installation configuration frames sent from the controller 410, the configuration processing module 170 determines whether the received installation configuration frames match the graphic features in the configuration script loaded by the script loading module 160. In this embodiment, suppose the installation configuration frame requires the user to click ‘Next’ and the graphic feature is part of the interactive frame. After the configuration processing module 170 uses the graphic recognition technique and if the configuration processing module 170 finds agreement between the graphic features in the configuration script and part of the configuration installation frame, then the configuration processing module 170 determines that the configuration installation frame matches the graphic features in the configuration script.

When the configuration processing module 170 determines that the configuration installation frame matches the graphic features in the configuration script, the configuration processing module 170 uses the transmission module 110 of the operating device 100 to transmit the interactive data corresponding to the matched graphic features to the controller 410 (step 370). In this embodiment, suppose the interactive data involve a single click and the coordinate is at the ‘Next’ button on the installation configuration frame.

After the controller 410 receives the interactive data sent from the configuration processing module 170, the controller 410 uses the received interactive data as the input to the server 400. The received interactive data are provided to the target program being configured so that the configuration procedure enters the next stage (step 380) until it is finished. With the invention, the user does not need to spend a lot of time on installing and configuring a server.

In the above-mentioned embodiment, if the operating device 100 further contains a progress displaying module 180, then the progress displaying module 180 can use the matched graphic features to display the progress of the configuration of the target program on the server (step 390). For example, the progress displaying module 180 uses the number of matched installation configuration frames as the divisor and the total number of graphic features in the configuration script as the dividend to compute a percentage. The percentage is displayed as the progress of the target program configuration on the server 400.

The following uses a second embodiment to explain the operating system and method of the invention, with reference to FIG. 2A. In this embodiment, suppose the target program is a combination of the OS and web page server software/database management system. That is, after the operating device 100 controls the server to install an OS, it continues to control the server to install web page server software/database management system so that the server can start providing web page/database services after the installation, without the need for the user to do extra works.

Suppose the user has already used the operating device 100 to record the graphic features generated while installation the OS and web page server software/database management system and the received interactive data to the corresponding configuration script (step 310). Therefore, the user can use the operating device 100 to control the server 400 to automatically configure target programs.

First, the transmission module 110 of the operating device 100 connects to the controller 410 of the server 400 to be configured with the target program (step 330). Afterwards, the script loading module 160 of the operating device 100 searches for configuration scripts stored in the storage media of the operating device 100 and those stored in external devices on the Internet via the transmission module 110 of the operating device 100. After the searches are finished, the configuration scripts thus found are displayed in the display frame of the operating device 100 to the user to select the one corresponding to the target program to be configured.

After the user selects a configuration script, the script loading module 160 of the operating device 100 loads the configuration script selected by the user. The configuration notification module 150 of the operating device 100 then notifies the controller 410 to start configuring the target program (step 350).

After the controller 410 receives the notification from the configuration notification module 150 of the operating device 100, the server 400 is controlled according to the notification to configure the target program. The controller 410 first follows the notification to install the OS on the server 400. When the controller 410 installs the OS on the server 400, the installation configuration frames displayed by the server 400 are sent to the operating device 100 (step 360).

After the configuration processing module 170 of the operating device 100 uses the transmission module 110 thereof to receive the installation configuration frames sent from the controller 410, the configuration processing module 170 determines whether the received installation configuration frames match with the graphic features in the configuration script loaded by the script loading module 160. When the configuration processing module 170 determines that the received installation configuration frames match the graphic features in the configuration script, the configuration processing module 170 sends the interactive data corresponding to the matched graphic features to the controller 410 via the transmission module 110 (step 370).

After the controller 410 receives the interactive data sent from the configuration processing module 170 of the operating device 100, the controller 410 uses the received interactive data as the input for the server 400. The received interactive data are provided to the OS being installed, so that the configuration procedure for the OS obtains the interactive data to enter the next stage (step 380) until the OS installation is over.

After the OS is installed, the controller 410 still transmits the installation configuration frame about the success in the OS installation to the operating device 100 (step 360). When the configuration processing module 170 of the operating device 100 follows the graphic features recorded in the configuration script to determine that the transmitted installation configuration frame includes an interactive frame asking for a login account and password, the configuration processing module 170 takes the account and password in the configuration script as the interactive data. The account and password of the OS are transmitted to the controller 410 via the transmission interface 111 of the operating device 100 (step 370).

After the controller 410 uses the received interactive data as the input of the server 400, the controller 410 logs into the OS. The controller 410 continues to send the frame of logging into the OS t the operating device 100 (step 360). When the configuration processing module 170 of the operating device 100 follows the graphic features recorded in the configuration script to determine that the transmitted installation configuration frame means a successful login into the OS, the configuration processing module 170 takes the control signal of clicking web page server software/database management system in the configuration script as the interactive data. The account and password for logging into the OS are transmitted via the transmission module 110 of the operating device 100 to the controller 410 (step 370).

After the controller 410 receives the control signal sent from the operating device 100, the controller 410 can use the received control data as the input for the server 400, so that the OS starts the configuration procedure of the web page server software/database management (step 380). Afterwards, as in the case of the OS installation, steps 360 to 380 are performed. During the process of installing the web page server software/database management on the server 400, the configuration processing module 170 of the operating device 100 transmits the interactive data. The controller 410 can control the configuration procedure to complete the installation of web page server software/database management. After the installation is completed, the web page server software/database management is executed to provide the web page/database service. Therefore, the user does not need to spend a lot of time on installing and configuring the server.

In summary, the invention differs from the prior art in that after the controller sends the installation configuration frames displayed while the server configures the target program to the operating device, the operating device determines whether the received installation configuration frames match with the graphic features in the pre-established configuration script. When they match, the interactive data corresponding to the graphic features are sent to the controller. The controller provides the interactive data to the target program being configured so that the configuration procedure enters the next stage. This solves the problem that server configuration cannot be automatically completed in the prior art. The invention achieves the goal of rapidly mass-configuring servers of the same type.

Moreover, the disclosed method of automatically configuring servers using a pre-recorded configuration script can be implemented in hardware, software, or their combination. It can be implemented in a centralized way among computer systems or in a distributed way among several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for automatically configuring a server using a pre-recorded configuration script, comprising the steps of:
connecting an operating device to a controller of a server;
using the operating device to notify the controller to configure a target program in the server;
using the controller to transmit an installation configuration frame displayed by the server while configuring the target program to the operating device;
when the operating device determines that the installation configuration frame matches with a graphic feature in a configuration script corresponding with the target program, transmitting interactive data corresponding to the graphic feature in the configuration script to the controller; and
using the controller to provide the interactive data to the target program for the configuration procedure of the target program to enter a next stage.

2. The method of claim 1, wherein the step of connecting an operating device to a controller of a server is preceded by the steps of using the operating device to receive at least one interactive frame transmitted from a controller of a recording device when the recording device configures the target program, generating the graphic features of the received interactive frames, and recording in sequence the graphic features and the interactive data inputted in the corresponding interactive frames to the configuration script.

3. The method of claim 1, wherein the step of connecting an operating device to a controller of a server further includes the step of searching for at least one controller and selecting one of the controllers thus found as the controller.

4. The method of claim 1, wherein the step of using the controller to transmit an installation configuration frame displayed by the server while configuring the target program to the operating device uses the controller to extract a video stream containing the installation configuration frames output by the server while configuring the target program and sends the video stream to the operating device.

5. The method of claim 1, wherein the step of using the controller to transmit an installation configuration frame displayed by the server while configuring the target program to the operating device uses the controller to determine when a video stream outputted while configuring the target program has consecutively several same installation configuration frames, to extract the same installation configuration frame from the video stream, and to send the extracted installation configuration frame to the operating device.

6. The method of claim 1, wherein the step of using the operating device to notify the controller to configure a target program in the server is followed by the step of using the operating device to display the progress of configuring the target program by the server based on the graphic features that match with the installation configuration frames.

7. A system for automatically configuring a server using a pre-recorded configuration script used on an operating device connected with a server having at least one controller, the system comprising:
a transmission module connected with the controller;
a script loading module for leading a pre-established configuration script that contains the graphic features of a plurality of interactive frames when configuring a target program and for inputting interactive data in the interactive frames, each of the graphic features having correspond the interactive data;
a configuration notification module for notifying the controller to configure the target program in the server; and
a configuration processing module for receiving an installation configuration frame displayed by the server while configuring the target program and transmitted from the controller, and determining whether the installation configuration frame matches one of the graphic features;
wherein when the installation configuration frame matches one of the graphic features, the configuration processing module transmits the interactive data corresponding to the matched graphic feature to the target program for the configuration procedure of the target program to enter a next stage.

8. The system of claim 7 further comprising a target selecting module for selecting one of the controllers found by the transmission module as the controller.

9. The system of claim 7, wherein the configuration processing module receives a video stream extracted by the controller from the output of the server while configuring the target program, with the video stream containing the installation configuration frames.

10. The system of claim 7, wherein the configuration processing module receives a same installation configuration frame extracted from a video stream outputted while configuring the target program by the controller when the video stream has a plurality of same installation configuration frames.

11. The system of claim 7 further comprising a script recording module for receiving a plurality of interactive frames transmitted from a controller of a recording device when the recording device configures the target program, generating the graphic features of the interactive frames, and recording the graphic features and the interactive data inputted in the interactive frames into the configuration script.

12. The system of claim 7 further comprising a script editing module for editing the configuration script so that the edited configuration script is more suitable for the server.
